(19) United States
(12) Patent Application Publication
(10) Pub. No.: US 2014/0205980 A1
(43) Pub. Date: Jul. 24, 2014

(54) SYSTEMS AND METHODS FOR EXERCISE ANIMATION SOFTWARE

(71) Applicant: Kiio Inc., Madison, WI (US)

(72) Inventors: Robert Braier, Fitchburg, WI (US); David Grandin, Madison, WI (US)

(73) Assignee: Kiio Inc., Madison, WI (US)

(21) Appl. No.: 14/161,472

(22) Filed: Jan. 22, 2014

Related U.S. Application Data
(60) Provisional application No. 61/755,787, filed on Jan. 23, 2013.

(51) Int. Cl. A63B 24/00; G09B 5/02

(52) U.S. Cl. CPC A63B 24/0062; G09B 5/02
USPC 434/247

(57) ABSTRACT

An exercise system for use with a computing device to modify and demonstrate an exercise. The exercise system may be used to modify exercises and to collect and track data based on exercise performance. Modifications to exercises may include range of motion, timing, and exercise routine modifications to customize exercises for use by a patient or athlete. A force sensing device can also be used with the exercise system to measure and track exercise data.

### CROSS REFERENCE TO RELATED APPLICATIONS

This application claims the benefit of U.S. Provisional Patent Application Ser. No. 61/755,787, filed Jan. 23, 2013, the disclosure of which is hereby incorporated by reference herein in its entirety for all purposes.

### FIELD OF THE INVENTION

The present invention relates generally to the field of exercise and rehabilitation. More particularly, the present invention relates to systems and methods for modifying and demonstrating targeted performance of selected exercises.

### BACKGROUND OF THE INVENTION

Performing exercises using the proper form, force and speed or timing is important in several applications, including physical or occupational therapy, coaching athletes, and fitness training. If any one of these elements is incorrect, the effectiveness of the exercise can be reduced, increasing the recovery time, decreasing effectiveness or causing injury to the patient or athlete.

In performing exercises, many patients and athletes rely on simple written descriptions, photos or drawings of exercises, or even just their memory about how exercises should be performed. However, ideal exercise form, force, and timing are difficult to effectively communicate in a purely static depiction of an exercise. Persons prescribing, coaching, or otherwise instructing others about recommended exercises (i.e. “exercise instructors”) can more accurately and effectively communicate information about exercises using an animated or video depiction of the desired exercise.

Exercise instructors, whether coaches, therapists, or other types of instructors, often modify exercises to best suit their patients or athletes. For example, modifications or customizations may be useful in connection with rehabilitation after injury, or to focus on training certain muscle groups. Examples of certain modifications can include adjustments to the range of motion or the timing of a given exercise. Some exercises can target different muscles when performed in a full range of motion than when performed in a smaller range. Different timing for an exercise can matter as well; fast repetitions of an exercise provides different muscle work than slow repetitions or exercises with specific hold times. Effectively specifying and communicating such modifications to exercises can be challenging.

Another aspect of the background is that resistance bands and other types of elastic exercise equipment can be very useful for therapy and fitness, but are under-utilized due to challenges in communicating how to use them effectively and challenges in measuring and tracking exercise work done with such devices. To measure and track exercises, force sensing devices can be used with resistance bands, for example as disclosed in U.S. Pat. No. 8,491,446 which is hereby incorporated by reference herein in its entirety for all purposes. Challenges in communicating and demonstrating how best to use resistance bands and the like still exist.

There is therefore a need for an exercise system to improve ease of communication and demonstration of exercises, including modified or customized exercises. An improved exercise system used in conjunction with resistance bands and/or a force sensing device can provide additional benefits in measuring and tracking exercise data for use in further modifying exercises and improving rehabilitation or fitness.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### SUMMARY OF THE INVENTION

In one embodiment, the invention provides an exercise system for use with a computing device to modify and demonstrate an exercise having a number of phases. The exercise system includes an interface for displaying a digital media of the exercise on the computing device. The exercise system also includes a start marker for indicating a segment of the digital media at which the exercise should start and an end marker for indicating a segment of the digital media at which the exercise should end. The exercise also includes a selection means for indicating a portion of the digital media representing each phase of the exercise. A processing means is also included for preparing a modified digital media based on the start marker and end marker and for indicating the portion of the digital media representing each phase. The modified digital media is used to demonstrate the exercise.

In other embodiment, the invention provides an exercise system for use with a computing device to modify a digital media of an exercise. The exercise system includes an interface capable of being displayed on a computing device for facilitating identification of a period of time for each phase of the exercise by receiving temporal inputs from a user. The exercise system also includes a selection means for indicating segments of the digital media representing each phase of the exercise. A processing means is also included for using the temporal inputs to set a speed at which the segments of the digital media representing each phase of the exercise are displayed on the computing device.

In other embodiment, the invention provides an exercise system for determining a force target at which an exercise having a number of phases is performed. The exercise system includes a sensor for measuring forces created during performance of the exercise and for sending a signal representing the measured forces. The exercise system also includes a memory for receiving the signal and a processor for determining a force target for the exercise based on the signal.

In other embodiment, the invention provides an exercise system for demonstrating an exercise routine. The exercise system includes a computing device having an interface and a library of digital media files of exercises on a server. The digital media are capable of being played on the interface. The exercise system also includes a processor for receiving data inputs regarding a selection of the digital media files for inclusion in the exercise routine. The exercise routine can be played by a second computing device to demonstrate the exercise routine.

Other objects and advantages of the invention will become apparent hereinafter.

### BRIEF DESCRIPTION OF THE DRAWINGS

FIG. 1 is a block diagram showing how exercises can be determined and communicated to a patient or athlete.

FIG. 2 is a frame-by-frame representation of animation digital media illustrating of an exercise.

FIG. 3 is a static illustration of the exercise of FIG. 2 showing the starting and ending range of motion.

FIG. 4 is a view of an interface of an embodiment of an exercise system in accordance with the invention showing a digital media representation of the exercise of FIG. 2.

FIG. 5 is a series of views from the interface of FIG. 4 showing the selection of digital media segments.

FIG. 6 is a view of an interface of the exercise system of FIG. 4 showing the selection of a user created media segment.

FIG. 7 is a printout created from the exercise system of FIG. 4 showing the starting and ending positions for the exercise of FIG. 5.

FIG. 8 is a view of an interface of an exercise system in accordance with the invention showing the user adjustable fields for the timing of an exercise represented by a digital media.

FIGS. 9A-C is a series of views of the interface of FIG. 8 showing the same exercise with different timing curves applied.

FIG. 10 is a view of an interface of an embodiment of the exercise system showing instructions for a routine of exercises.

FIG. 11A is a graph showing the desired timing curve for an exercise.

FIG. 11B is a graph showing the desired timing curve for an exercise of FIG. 11A overlaid with the captured timing of a patient or athlete performing the exercise.

FIG. 12 is a view of an interface of an exercise system in accordance with the invention showing adjustable input fields for modifying or customizing an exercise.

FIG. 13 is a view of another interface of an exercise system in accordance with the invention showing additional adjustable input fields for an exercise.

FIG. 14 is a block diagram of the playback of a selected digital media segment.

FIG. 15A is a block diagram of the playback of a selected digital media segment in accordance with the selected timing information.

FIG. 15B is a continuation of the block diagram of FIG. 15A of the playback of a selected digital media segment.

### DETAILED DESCRIPTION

An exercise system in accordance with the present invention helps exercise instructors customize and communicate information or instructions about exercises to patients and athletes. The system may also measure and track information about the patient or athlete performing exercises for use by an exercise instructor to modify or customize exercises based on the needs or goals of the patient or athlete.

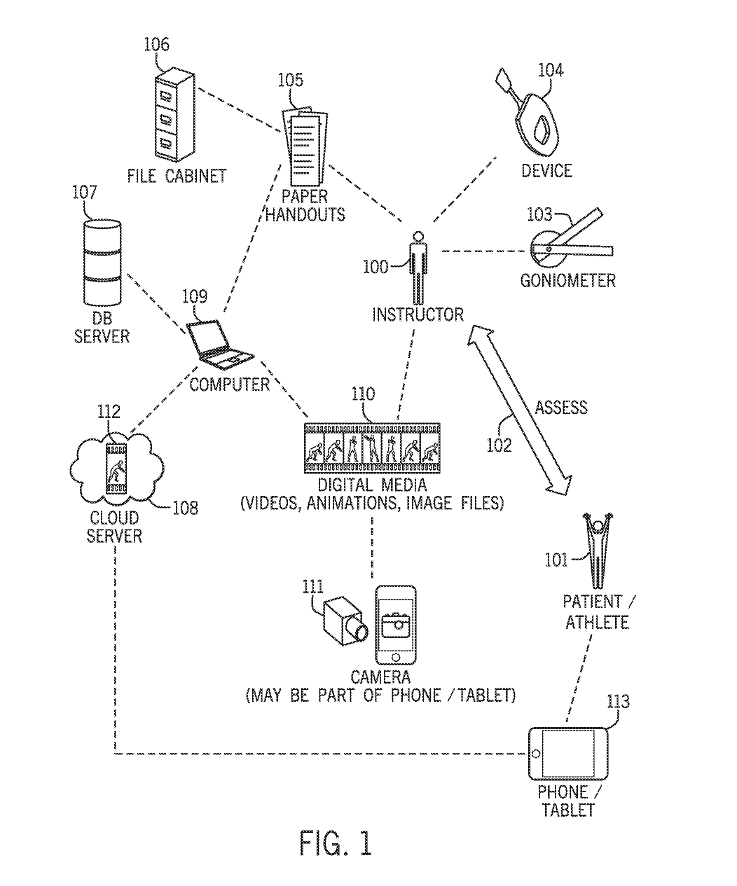

Referring now to FIG. 1, which illustrates a common interplay between an exercise instructor 100, such as a coach or physical or occupational therapist, and a patient or athlete 101. An exercise instructor 100 meets with a patient or athlete 101 and performs an assessment 102 on him/her in order to help determine the proper course of treatment or recommended fitness or training plan for the patient or athlete 101.

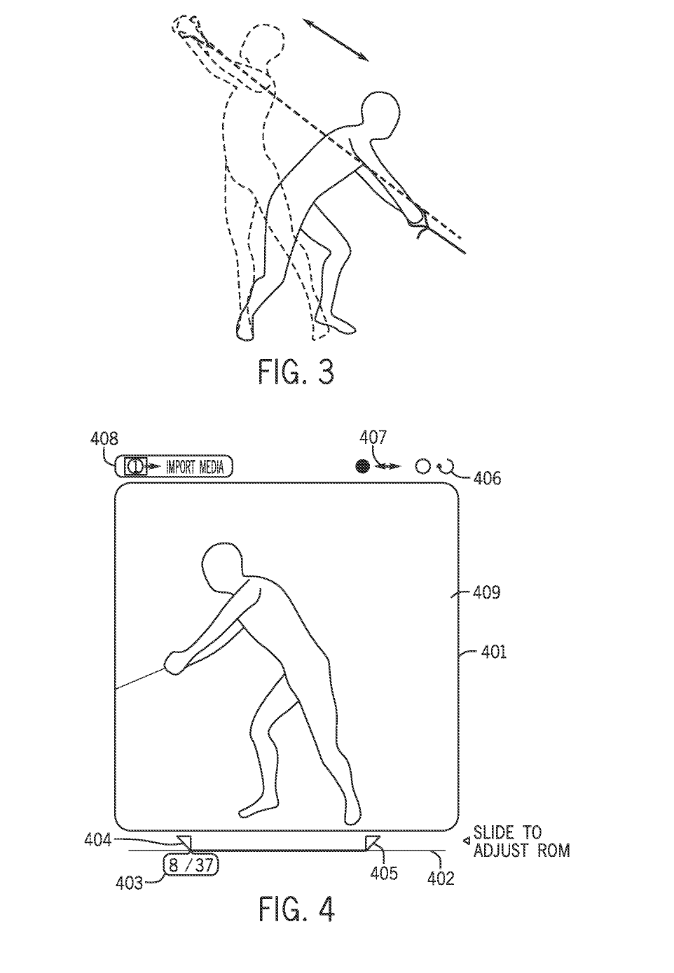

Exercise instructors 100 can give the patient or athlete 101 handouts 105, such as from a filing cabinet 106 or a computer 109, illustrating an exercise or information about an exercise or exercises, such as the starting position and ending position of an exercise as can be seen in FIG. 3. But information about exercises and customizations of exercises, such as timing variations and/or range of motion modifications, can be difficult to communicate by handouts or written documents, and can better be shown by video or animated depictions.

To do so, an exercise instructor 100 may access, select, and if appropriate, modify, digital media 110 for use within the exercise system. Digital media includes many formats for displaying visual information about an exercise within the system. For example, digital media could be a video, an animation, a drawing, or a set of drawings or still images. Digital media 100 may be stored on, for example, a computer, a database server 107 or a cloud-based server 108, or other hardware accessible for the system. Digital media 100 may be a single file or may represent a single exercise, but could also be provided in a digital media library representing media for multiple exercises. If the existing digital media library does not contain a desired exercise, some exercise instructors may even use a camera 111 to take a series of pictures and/or a video of a model performing an exercise, to be later imported into the systems and perhaps also customized.

Patient or athlete specific digital media 112 along with the associated exercise parameters/details may be uploaded from a computer 109 to an internet cloud server 108 and securely stored on a per-person basis. The patient or athlete 101 may then use paper handouts 105 or access the patient or athlete specific digital media 112 stored on the cloud 108 via his or her own smart phone, computer or tablet 113.

Exercises for athletes or patients may need to be adjusted for optimal effectiveness. For example, some patients are restricted in their Range of Motion (ROM) due to injury or other sources of pain. As such, only a portion of an exercise is appropriate to accommodate the limited ROM, with the range perhaps gradually increasing over time as the patient's performance improves.

Further, different injuries or fitness goals may require the same exercises performed at different speeds and/or timings. The frequency at which an individual repetition is performed can impact the effectiveness of a particular exercise movement because different muscle physiology takes place. Determining the proper force at which resistance band exercises should be performed is also important. However, the static nature of written materials makes communicating modified exercises difficult and confusing, resulting in decreased effectiveness or incorrect performance of such exercises.

Referring to FIG. 1, during an assessment 102 or in the presence of an exercise instructor 100, a goniometer 103 and other tools and techniques such as a force sensing device 104 to assess a patient or athlete's strength may be used to measure the patient or athlete's ROM.

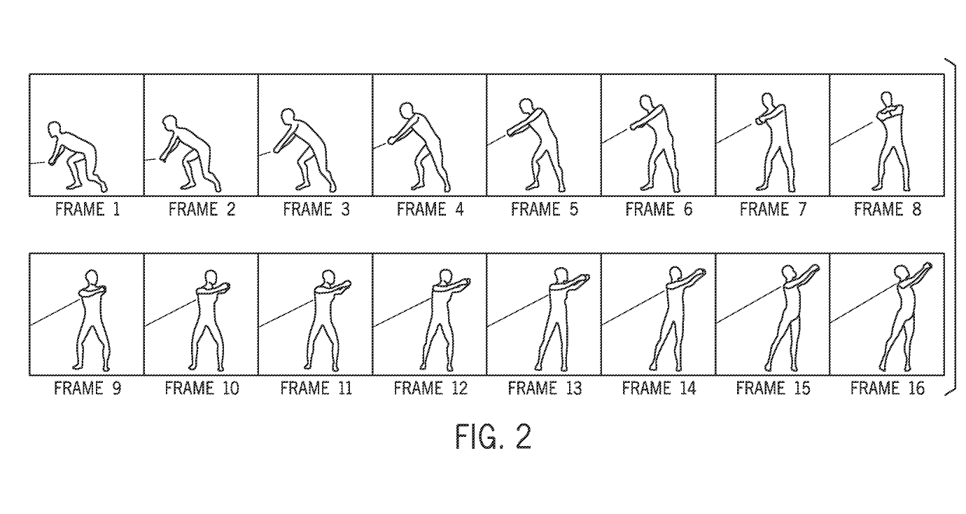

In one aspect of an exercise system in accordance with the invention, an exercise instructor can modify and customize the range of motion for an exercise by designating starting and ending points for the exercise. For example, a video, animation, or other visual representation of an exercise can be broken down into a series of frames. As seen in FIG. 2, for example, a low to high wood chop exercise is broken down into sixteen different frames. The series of frames could also be, for example, a set of images. Using the exercise system, an exercise instructor can designate starting and ending positions for a given exercise by selecting a starting frame and an ending frame to thereby create a customized visual representation of the exercise showing the specific range of motion tailored for the exercise. This technique can be applied to videos and/or series of images in a pre-existing exercise library, or that are externally created and then imported into the system (e.g. digital media 110).

FIG. 4 shows one embodiment of an interface for use with an exercise system for viewing digital media and to aid in interacting with the system. Here, the digital media 110 is shown in a media viewer window 401 on a computing device of some type such as computer 109. The media viewer window 401 is an area where the digital media frames are displayed for the exercise instructor 100 to view the exercise motion. The line 402 below the media viewer window 401 can be a representation of the timeline for the digital media 110. The exercise instructor 100 can click on the image 409 in the media viewer window 401 to toggle between play and pause of the digital media 110. Alternatively, play and/or pause buttons could also be provided. The exercise instructor 100 can slide the scrub control button 403 to the left and right, allowing the instructor to scrub through the digital media frames, playing them one at a time at a pace he/she desires. As the scrub control button 403 is slid, the frame number updates within the scrub control button and the media viewer window 401 updates to show the associated frame.

The system may be used modify and demonstrate exercises where the start and end points of an exercise are customized to a patient or athlete. This may be useful for ROM limitations, or pain issues, or to customize exercises for an athlete's particular fitness goals. To select a starting point within the digital media 110, the exercise instructor 100 can slide the start marker 404 to the desired frame. As the start marker 404 is moved, the frame in the media viewer window 401 is updated to show the associated frame. To select an end point within the digital media 110, the exercise instructor 100 can slide the end marker 405 to the desired frame. As the end marker 405 is moved, the frame in the media viewer window 401 is updated to show the associated frame.

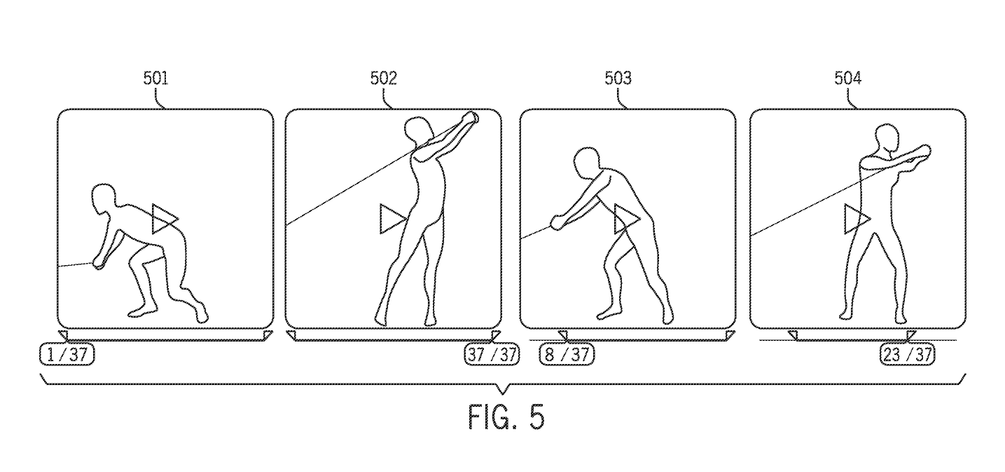

This functionality could be used to modify exercises for a range of purposes, one of which is to customize the ROM for a given exercise. FIG. 5 illustrates a sequence of steps an exercise instructor 100 might perform in order to specify the ROM for a given exercise for a particular patient or athlete 101. When first viewing an exercise, the first frame 501 is displayed in the media viewer window 401 such as on a computer, phone or other computing device 109. The exercise instructor 100 can slide the scrub control button 403 to the last frame 502 to determine the default end of ROM for the exercise. The exercise instructor 100 can drag the start marker 404 to the selected start frame 503 or segment for the patient or athlete 101. The exercise instructor 100 can then drag the end marker 405 to the selected end frame 504 or segment for the patient or athlete. The modified digital media 510 can be prepared by the system as described running on a computing device, e.g. 109, or other such processing devices. The result is a modified digital media 510 starting at the selected start frame 503 and ending at the selected end frame 504 to be shown on for example, a computer, phone or other computing device 113, thus providing the proper exercise illustration for the desired ROM.

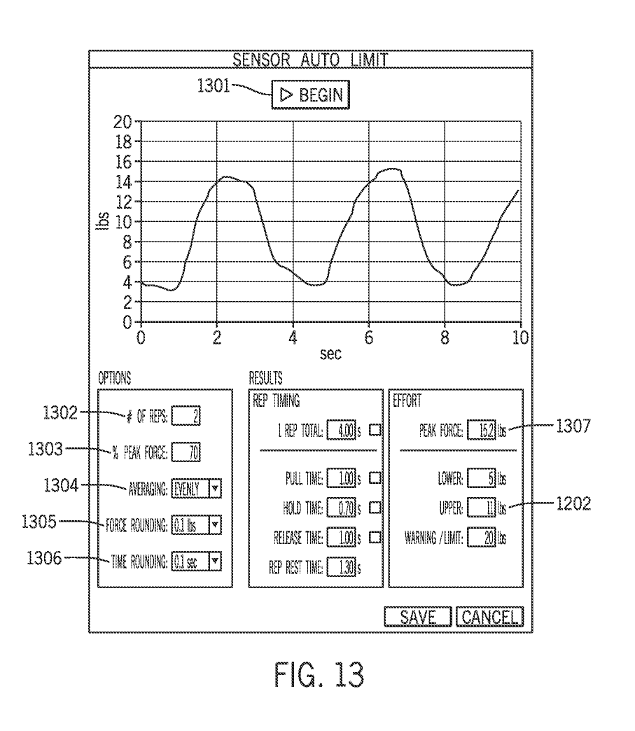

The modified digital media 510 can be saved for future use in number of ways. For example, in one embodiment, every time the selected start frame 503 and/or selected end frame 504 is changed, the system will save the changes. In another embodiment, there can be save and/or cancel buttons, such as seen in FIG. 13, that can be selected to save or cancel such changes.

The exemplar interface illustrated in FIG. 4 can also include additional features. One example of such additional features is a loop control 406 and a reverse control 407 to specify the playback method of the digital media, such as loop-to-start or back-and-forth, respectively.

The loop control 406 is used to designate that the modified digital media 510 should be played from start to finish, and then upon showing the selected end frame 504, return to the selected start frame 503 and play the modified digital media 510 all over again from start to finish. This is useful for exercises which are not symmetrical in their movement (e.g., walking forward).

The reverse control 407 is used to designate that the modified digital media 510 should be played from the selected start frame 503 to the selected end frame 504, and then upon showing the selected end frame, the modified digital media 510 should be played in reverse—from the selected end frame 504 to the selected start frame 503. In effect, the modified digital media 510 from the selected start frame 503 to the selected end frame 504 only shows half of the exercise movement. This is useful for exercises which are symmetrical in their movement (e.g., an arm curl).

The exemplar interface illustrated in FIG. 4, can also hide undesired controls. For example, if only a single frame is used as the digital media, such as when the exercise is an isometric exercise, some or even all of the various playback controls 402, 403, 404, 405, 406, 407 can be hidden.

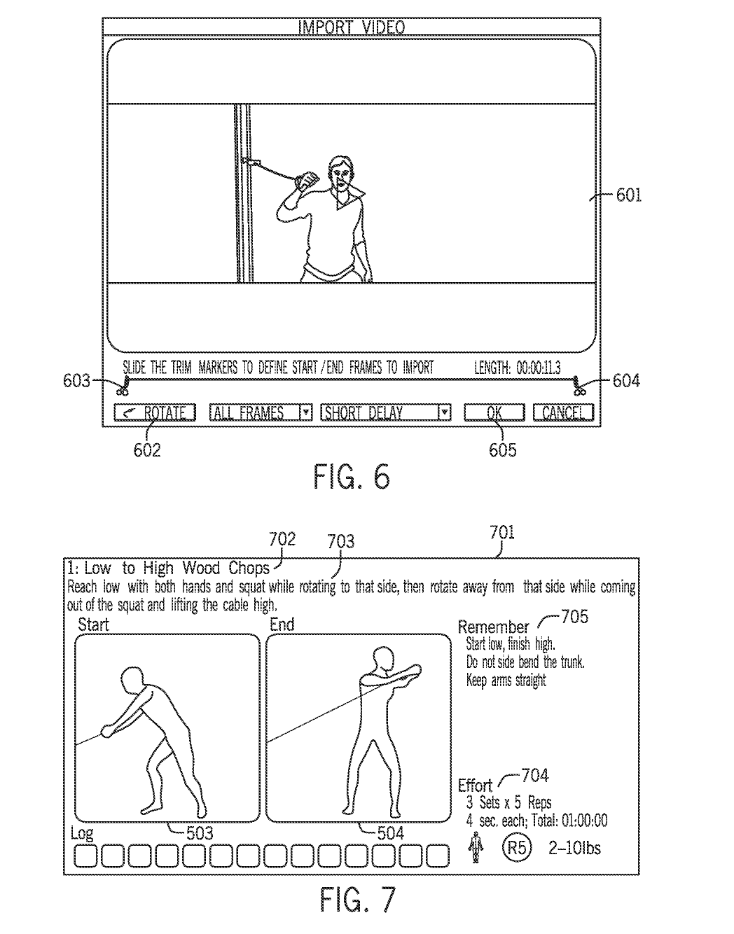

As mentioned above, an exercise system can also be used with user-created digital media 511. For example, the exemplar interface illustrated in FIG. 4 includes an import button 408. Selection of the import button 408 allows an exercise instructor 100 to import or upload his or her own still images, e.g. jpeg, jpg, bmp, gif, and/or video files, e.g. mp4, mpeg4, avi, mov, m4v, wmv, such as through a browse dialog. FIG. 6 shows an exemplar embodiment of an interface for importing a user-created digital media 511.

With reference to FIG. 6, the imported user-created digital media 511 can be displayed in a preview area 601. The interface includes features that allow the user to edit the user-created digital media 511. For example, the interface includes a rotate button 602 that upon selection will rotate the user-created digital media 511 ninety degrees. The interface also allows the user to trim the user-created digital media 511 by selecting the start trim marker 603 and end trim marker 604. Once the appropriate starting and ending point of the user-created digital media 511 is selected, the OK button 605 can be selected to begin the conversion of the user-created digital media 511 into an encrypted frame format. Once converted, the user-created digital media 511 can be used with the interface shown in FIG. 4 as described above. In one embodiment, the system can be instructed to permanently remove the digital media before the start trim marker 603 and after the end trim marker 604 during conversion, so as to edit the digital media to show only the exercise, and not setup or rest time before or after the exercise. This is to aid in making sure only 1 repetition (or ½ of a repetition for those digital media set to play back-and-forth) is imported for subsequent use. However, there may be instances where more than one repetition is desired. Alternatively, the start and end trim markers 603, 604 could have functionality similar to the start/end markers 404, 405 previously described.

In addition to the creation and revision of digital media, the system can also create electronic or hard copy handouts. For example, the selected start frame 503 and the selected end frame 504, such as designated by the start and end of the start and end markers 404, 405, can be printed on patient or athlete exercise handouts 701, an example of which is shown in FIG. 7. The patient or athlete exercise handouts 701 can also include, for example, the name of the exercise 702, description of the exercise 703, the number of repetitions and force 704, and/or a space 705 for the exercise instructor 100 to add notes for the patient or athlete 101.

By using the system, one piece of digital media for an exercise has the potential to be tailored to represent many patient or athlete specific exercises, helping to convey to patients or athletes the proper movement or ROM for an exercise.

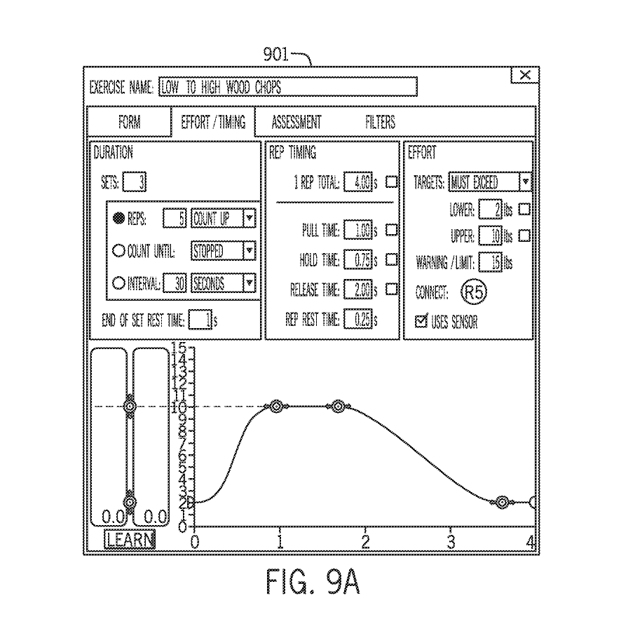

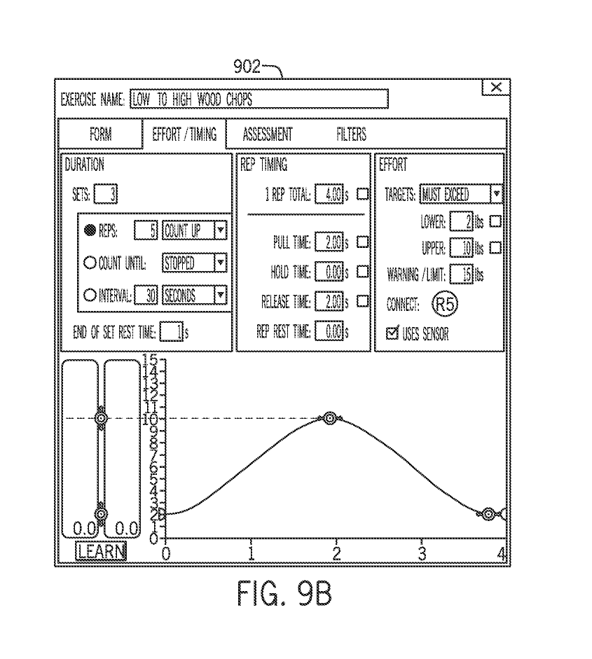

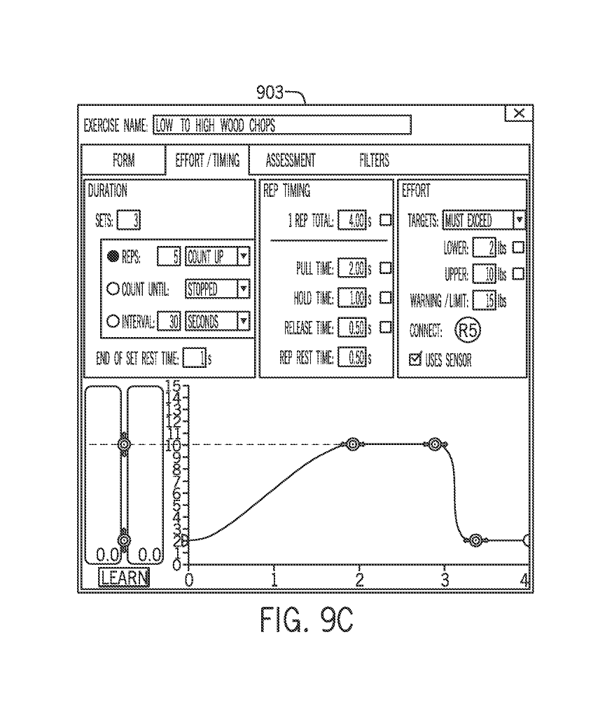

In accordance with another aspect of the invention, the system allows an exercise instructor to designate the timing sequence and/or speed for a given exercise. To do so, an exercise can be broken down into different phases. Any number of phases could be assigned to an exercise. For example, in a two phase exercise, there may be a work phase and a release phase. Assigning four different phases, the exercise would have a pull (or push) phase, a hold phase, a release phase and a rest phase. Other numbers of phases could be used as well within the invention. Performing a repetition for an exercise using the correct phases and the correct timing for each phase is important to accomplish the desired goals. With the system, an exercise instructor can designate the timing for each phase of an exercise such that the playback of the resulting digital media matches the prescribed exercise timing. Such digital media can be prepared by the software as described running on a computing device, e.g. 109, or other such processing devices, to set the speed at which each phase of the digital media is subsequently displayed. Although most exercises logically have four phases, some exercises effectively use less than all four phases. For example, when the hold and rest phases may be set to zero, such as shown in FIG. 9B. This application can also be used with user-created digital media 511.

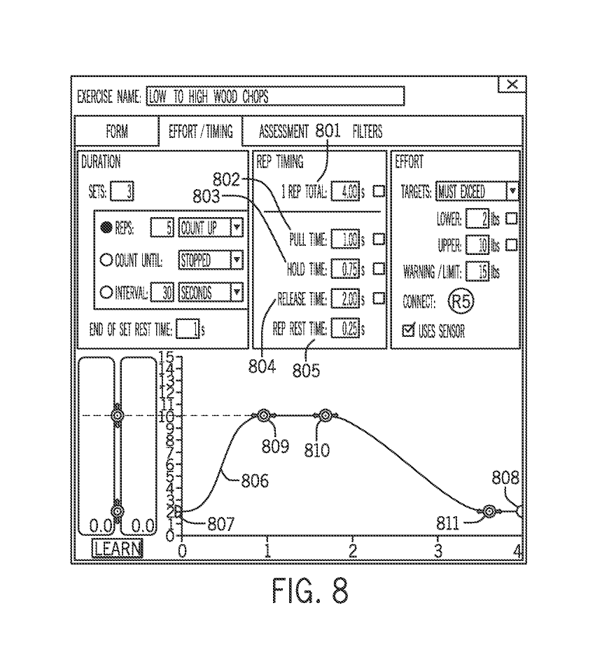

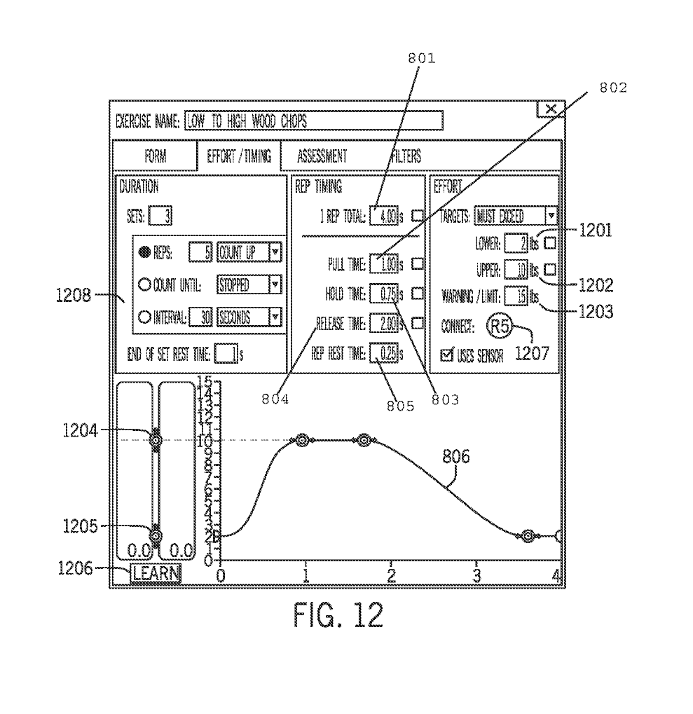

Referring to FIG. 8, which shows one embodiment of an interface. The interface or display shown in FIG. 8 allows or facilitates an exercise instructor to designate, select and/or otherwise indicate the timing for each phase of an exercise via temporal inputs either by entering the period of time for each phase, referred to as data entry, or by manipulating a curve representing the period of time for each phase, referred to as curve manipulation. The interface also allows the designation or identification of various duration parameters 1208 as seen in FIG. 12 through the entry of duration inputs, such as a repetition input or set input. The duration parameters 1208 can include a target number of sets and the identification of what constitutes a set. In the embodiment shown in FIG. 12, a set can be a target number of repetitions, an interval of time or counting. The counting feature can include counting the number of repetitions until a certain parameter is reached, e.g. heart rate, physical limitation, etc., or until an instructor or the patient or athlete stops the set.

The interface shown in FIG. 8 has a number of data entry fields 802-805 which an exercise instructor can use to enter, indicate or input numeric values or times for each of the four phases of the therapeutic exercise for the selected patient or athlete. The four times from these numeric representations of the periods of time for the phases are added together to arrive at the full time for one repetition shown in the full repetition field of the interface labeled 1 Rep Total 801.

In the exemplar interface shown, the pull phase is designated for 1 second in the pull time field 802. The hold phase is designated for 0.75 seconds in the hold time field 803. The release phase is designated for 2 seconds in the release time field 804. The rest phase is designated for 0.25 seconds in the repetition rest time field 805. The full repetition time is the sum of these four phases, in this example 4 seconds, as seen in the 1 Rep Total field 801.

In the interface embodiment shown in FIG. 8, the full repetition time can be changed directly by entering a value into the 1 Rep Total field 801. Upon which, the system will update each of the four phase fields 802-804 in proportion to the overall time.

For example, if the 1 Rep Total field 801 was changed to 8 seconds in the above illustration, which is double the original entry, then the four phase data entry fields 802-805 would be also doubled to 2 seconds, 1.5 seconds, 4 seconds, and 0.5 seconds, respectively. A graphical display may be shown below the data entry portion of the interface wherein each phase of the exercise is represented as function of the time based upon the information entered in the data entry fields 801-805.

An exercise instructor can also manipulate the timing curve 806 by sliding the target controls 809, 810, 811, representing the transitions between an exercise's phases as a function of time, left and/or right on the timing curve, the gap between each target control being representative of the respective phase. For example, the gap between the first target control 809 and second target control 810 is representative of the hold phase as indicated by the hold time field 803. To further ease use, the target controls can also be color-coded to match the phase fields. As the timing curve 806 is modified, the corresponding numbers in the data entry fields 802-805 are updated accordingly.

As an example, the timing curve 806 shown in FIG. 8 shows the timing curve for 1 Rep Total 801, with the start of the single repetition beginning at the start indicator 807, and ending at the end indicator 808 (4 seconds in the example shown). Selection of the first target control 809 and sliding it to the left makes the distance between start indicator 807 and first target control 809 shorter and, likewise, the pull phase shorter, as indicated in the pull time field 802. Sliding the first target control 809 to the left also makes the distance between first target control 809 and second target control 810 correspondingly longer and, likewise, the hold time phase longer as indicated in the hold time field 803.

Selection of the second target control 810 and sliding it to the left or right makes the hold phase, the distance between first target control 809 and second target control 810, shorter or longer respectively and the release phase, the distance between the second target control 810 and third target control 811, longer or shorter, respectively. Selection of the third target control 811 and sliding it to the left or right makes the release phase, the distance between the third target control 811 and second target control 810, shorter or longer, respectively, and the rest phase, the distance between the third target control 811 and end indicator 808, longer or shorter, respectively. The system makes designating the phase timing both intuitive and easy to configure.

FIGS. 9A-C show a number of the same exercise templates as in FIG. 8, but with different timing curves applied. The timing curve shown by the interface 901 in FIG. 9A is the timing for an exercise, as described above. The timing curve shown by the interface 902 in FIG. 9B is for equal pull time or concentric phase and release time or eccentric phase (each phase being 2 seconds) without any time for the rest phase or hold phase. The timing curve shown by the interface 903 in FIG. 9C is a slow pull phase of 2 seconds, a moderate hold phase of 1 second, a rapid release phase of 0.5 seconds and 0.5 seconds for the rest phase. The variations in timing shown in FIGS. 9A-C result in different unique exercises for the muscles used. The timing information can be saved as described with respect to the modified digital media 510 above.

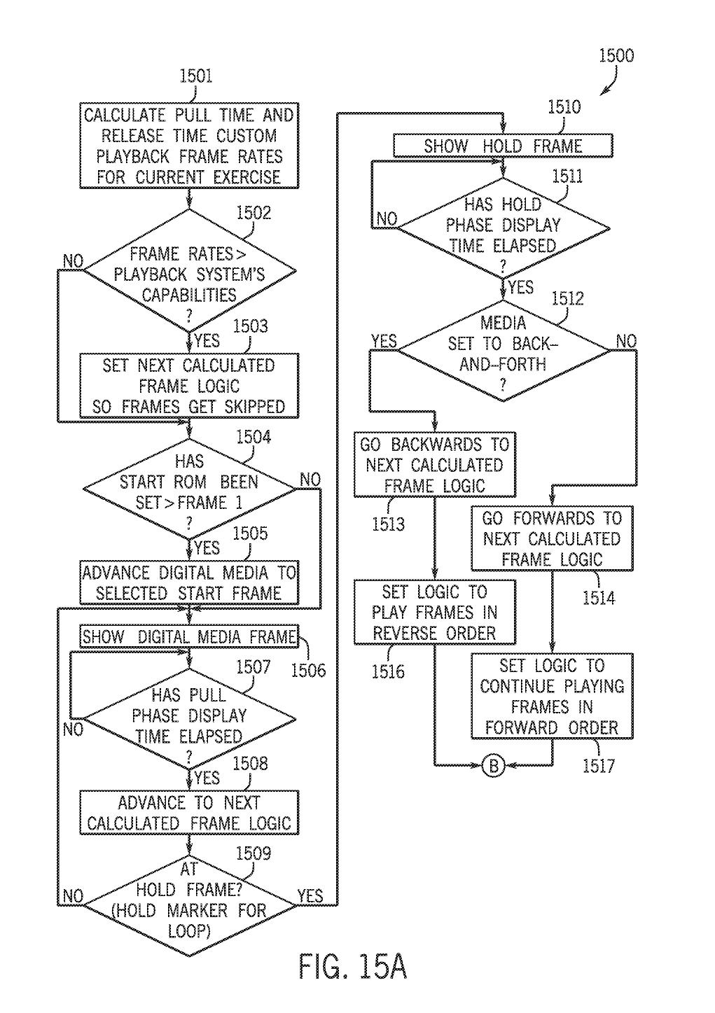

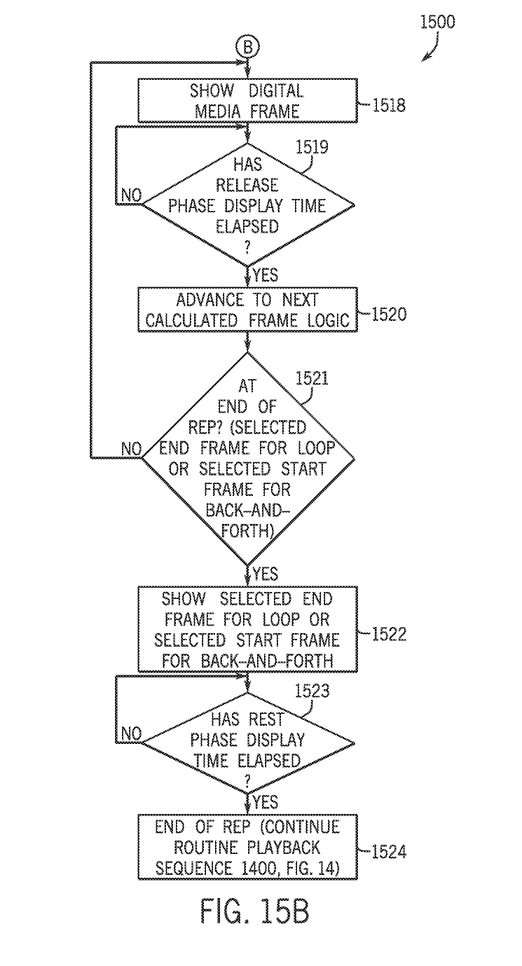

Once the timing information or temporal inputs are entered, such as by data entry or curve manipulation, the information is interpreted by the system and can be used in a number of ways. One way the temporal input information can be used is to directly affect the playback timing of the digital media as shown in FIGS. 15A and 15B. Such digital media could be any digital media, such as modified digital media 510, user-created digital media 511 or stock digital media. The method of playback can also depend upon the selection of the loop control 406 or reverse control 407.

For example, when the reverse control 407 is selected for an exercise, the system could begin playback of the modified digital media 510 by playing the modified digital media from the selected start frame 503 to the selected end frame 504 within the time allocated to the pull phase as indicated in the pull time field 802. The playback could then be paused or frozen on the selected end frame 504, showing that frame for the duration of the hold time phase as indicated by the hold time field 803. The playback would then continue with frames being played in reverse order from the selected end frame 504 to the selected start frame 503 within the time allotted for the release phase as indicated by the release time field 804. This portion of the playback is the return phase or second half of the exercise motion. The playback could then be paused or frozen at the selected start frame 503 for the duration of the rest phase as indicated by the repetition rest time field 805.

Such a system makes customizing an exercise extremely convenient because each of the phases is inherent in the back-and-forth frame design. The system correlates the digital media to the timing curve. No additional marking of the digital media is necessary, as each of the phases is inherent in the reverse control 407.

Another example, when the loop control 406 is selected for an exercise, the system could begin playback of the modified digital media 510 at the full repetition time as indicated by the 1 Rep Total field 801, without incorporating the specific timings of the data entry fields 802-805 because no frames have been identified for each phase. However, the repetition rest time field 805 could be used to indicate the period of time between the end of the digital media and the replay or playback of the digital media.

Alternatively, when the loop control 406 is desired for an exercise, the exercise instructor can identify and select the frame representing the start of the hold phase, or hold frame. The system can then pause or freeze the playback of the digital media at the appropriate point within the exercise, the hold frame, wherein the patient or athlete is to hold the pose for the duration specified in the hold time field 803, and use the duration identified in the pull time field 802 and release time field 804 to playback the digital media at different frame rates for those phases as shown in FIGS. 15A and 15B.

The system can adapt digital media so that the digital media can be displayed at variable speeds in each of the phases of the exercises at the precise timing desired irrespective of the industry accepted playback speed for that type of digital media, e.g. 29.97 frames per second for NTSC television, or 24 frames per second for film. The system allows a single digital media file or piece of digital media for an exercise to be modified into numerous exercise variations.

The system can also be used with custom user-created media files, such as video files or sets of still images. For example, the system can alter a user-created video such that the playback timing matches the patient or athlete's needs.

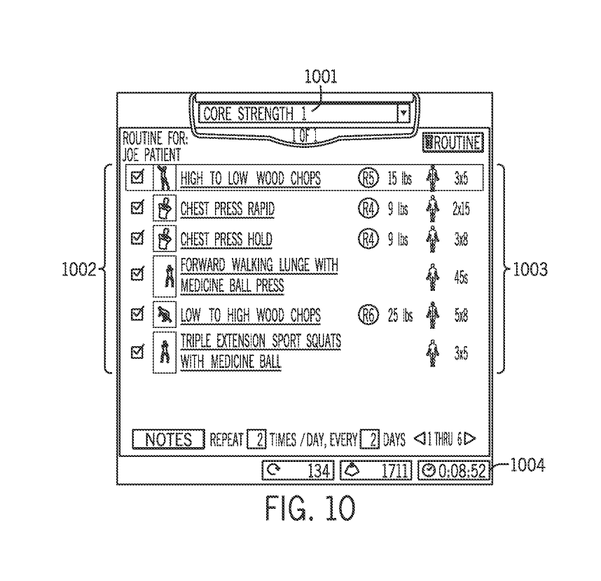

The tallying of a given routine's exercise time is another application of the timing information. The interface screen embodiment shown in FIG. 10 shows a sample routine of exercises. Identification of the routine can be accomplished by selection or a pre-assigned group of exercises, such as through a drop down menu, the election of individual exercises that comprise the routine or other similar routine inputs. “Routine inputs” include input fields, parameters or controls that can be adjusted, selected or manipulated to specify or customize an exercise or a series of exercises for a workout or therapy session.

In FIG. 10, the screen displays which therapeutic routine 1001 is prescribed, e.g. Core Strength 1, along with details of which exercises 1002 have been assigned, six different exercises in the example provided. Since the full repetition time indicated in the 1 Rep Total field 801 is known, the system can calculate an estimated completion time 1004 for which the routine 1001 of exercises 1002 will take for a patient or athlete 101 to perform based additionally on the duration parameters 1208 such as the number of repetitions and sets per exercise 1003 prescribed. The estimated completion time 1004 can be used by an exercise instructor 100 to better understand if too many exercises, or the repetitions within those exercises, have been prescribed or too few, for a given patient or athlete 101. The estimated completion time 1004 can also allow the patient or athlete 101 to allocate enough time to complete the routine 1001. More accurate estimated completion time 1004 as a result of the more accurate exercise timing, can lead to better patient or athlete results. The interface shown in FIG. 10 could be provided for printing or the estimated completion time 1004 could be included on patient or athlete exercise handouts 701 as seen in FIG. 7.

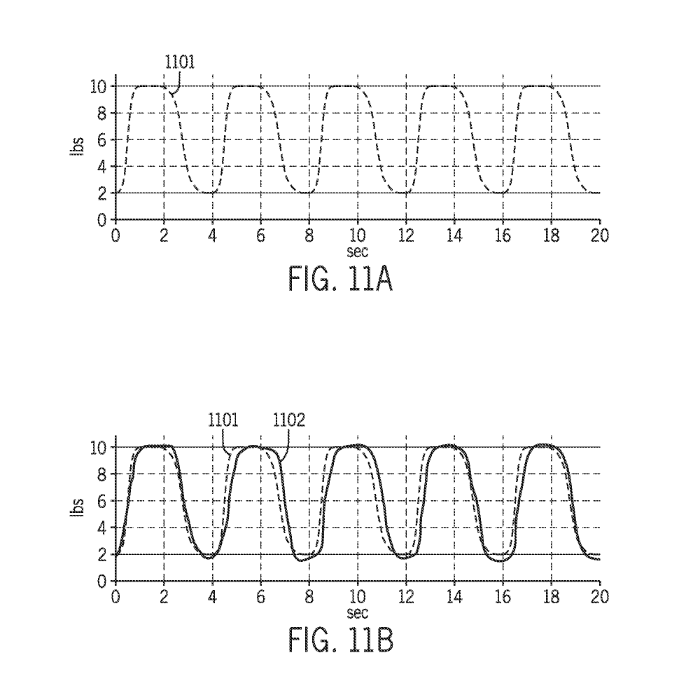

A “follow the curve” feature of the system is another application of the timing information when used with a force sensing device 104 such as that described in U.S. Pat. No. 8,491,446. In the interface embodiment shown in FIGS. 11A and 11B, an expected performance curve 1101 is plotted as a dotted line, with time plotted on the X axis and force in pounds on the Y axis. The curve 1101 in FIG. 11A has the desired performance timing for five repetitions of the exercise configured in FIG. 8. Using a force sensing device 104, to measure the force exerted by the patient or athlete 101, a patient or athlete can then attempt to trace the curve 1101, thereby being guided to help follow the specified timing and/or force for each exercise. As the patient or athlete performs the exercise, the system uses the force data 1102 provided by the force sensing device 104 and plots it as a dark solid line overlaid on the targeted curve 1101 as seen in FIG. 11B.

The combination of presenting the estimated completion time 1004 of the routine 1001, the digital media with the proper ROM and the proper timing, and a follow-the-curve performance graph based on sensor readings, creates a significantly easier to understand and fun exercise regimen for the patient or athlete leading to greater adherence and greater safety.

In accordance with another aspect of the invention, the system allows an exercise instructor to determine and designate the force parameters for each phase of a given exercise. Exercise instructors accustomed to using weights, such as dumbbells, may not be familiar with, or know how to prescribe, specific forces for phases of an exercise. Even those instructors who are accustomed to using resistance bands may not know what forces the patient or athlete is being subjected to or outputting in each phase of an exercise. For example, it may not be common for exercise instructors to give instructions such as ‘use the R7 Green cable and pull for 1 second up to 15.2 lbs. and hold for 1.5 seconds, then release over 2 seconds but keep 4 lbs. of tension on the cable at the end of ROM.’ With the exercise system, an exercise instructor can use force inputs to designate the force for each phase of an exercise. For example, the target controls 809, 810, 811 could be adjustable vertically to adjust force in addition to being movable horizontally to adjust times. Similarly, the start and end indicators 807, 808 could be adjustable vertically to adjust force. The force information can be saved as described with respect to the modified digital media above.

Referring to FIG. 12, the interface shown has a number of data entry fields which an exercise instructor can use to enter such force inputs as a lower force target field 1201 for a minimum force, an upper force target field 1202 for a maximum force and a warning limit field 1203 for a warning force. The force targets can be processed by running the software herein described on a computing device, e.g. computer 109, to represent each phase of the exercise, and the transitions between each phase, as a function of the force targets such as seen by the timing curve 806 in FIG. 12.

The lower force target field 1201 indicates the amount of force which should be applied even when in the relaxed position of the exercise. For some exercises, an exercise instructor may require the patient or athlete to maintain a minimum force throughout the exercise. In the example shown in FIG. 12, the lower force target field 1201 is 2 pounds.

The upper force target field 1202 indicates the amount of force the patient or athlete should achieve at the peak of his or her exercise movement. In the example shown, the upper force target field 1202 is 10 pounds.

The warning limit field 1203 indicates the amount of force above which the patient or athlete should be warned that he or she is applying too much force. In the example shown, the warning limit field 1203 is 15 pounds. This is helpful, for example, to make sure the patient or athlete doesn't over-exert him/herself and perhaps reinjure or otherwise impede his/her healing process.

As with the timing parameters, in another embodiment, the upper and lower force target fields 1201, 1202 can also be set by manipulating the timing curve 806. To manipulate the timing curve 806, the upper target control 1204 can be slid up and down to set the upper force target parameter or ending force for the pull phase, the hold phase force and the beginning force for the release phase. The lower target control field 1205 can also be slid up and down to set the lower force target parameter or the beginning force for the pull phase, the ending force for the release phase and the rest phase force.

Although an exercise instructor may rely on his or her experience to determine what force to enter in the force fields 1201-1203, such determinations will only be guesses because each patient and athlete will require a force tailored to the patient or athlete's needs and limitations. One aspect of the invention allows the values of the force fields 1201-1203 to be learned during performance of the exercise by the patient or athlete using a force sensing device 104.

FIG. 12 shows an interface of the system having a learn button 1206 that, when selected, causes the system to receive a data stream from a force sensing device 104. While the system is in ‘learn mode,’ the exercise instructor 100 will work with the patient or athlete 101 to perform exercises, such as to determine the limits of the patient or athlete. While in ‘learn mode,’ the system can be set to receive and set many different force parameters.

In one example, a force sensing device 104 is used to measure the forces of an exercise and sends a signal representing the measured forces to a memory in a computing device running the system as described herein, such as computer 109. The memory receives the signal and the processor of the computing device determines a force target based upon the signal received by the memory. The memory may also receive timing information and the processor may be capable of using the timing information to determine a period of time for each phase of an exercise.

For example, the system while in ‘learn mode’ may determine the peak force exerted by the patient or athlete 101. The system may use a percentage, such 75%, of the peak force, to set the upper force target field 1202. The system may also determine the force remaining after the repetition has been completed and use that force to set the lower force target field 1201. The system may also determine the time it took for the patient or athlete to transition from the lower force target field 1201 to the upper force target field 1202 and use that time interval to set the value for the pull time field 802. The system may also determine the time the patient or athlete was able to maintain the force above the upper force target field 1202 and use that time interval to populate the hold time field 803. The system may also determine the time it takes the patient or athlete 101 to release from the upper force target field 1202 to the lower force target field 1201 and use that interval to set the value for the release time field 804. If the patient or athlete 101 performs multiple repetitions, the system can monitor the time the force was below the lower force target field 1201 and use that information to set the repetition rest time field 805.

Thus, parameters for both the force fields 1201-1203 and data entry fields 801-805 can be monitored and tracked by the system specifically for the patient or athlete 101 and precisely for the exercise. Those parameters can then be entered in as a starting point for the exercise instructor to further customize. Not only does this provide for more accurate settings of these parameters, but also reduces the amount of computer data entry time required by the exercise instructor 100, which in turn enables more face-to-face time with the patient or athlete 101.

After ‘learn mode’ has completed filling in the fields with values, the exercise instructor 100 can review those values and make adjustments for the specific patient or athlete 101. For example, the instructor may decide that the upper force target field 1202 should be 70% of the peak force instead of 75%.

The ‘learn mode’ interface can also have advanced features for refining and directing the system through the use of additional parameters as seen in FIG. 13. Some of the advanced features that can be included in the interface are fields for: the number of repetitions 1302 to analyze, the percentage of peak force 1303 to use in setting the upper force target field 1202, the weighted average adjustment to use when analyzing data from multiple repetitions 1304 (e.g. evenly, first ⅓, last ⅓, custom), the force equalization or rounding 1305 (e.g. 0.1, 0.25, 0.5, 1.0 pounds), and the timing quantization or rounding 1306 (e.g. 0.01, 0.1, 0.2, 0.5 seconds). The advanced features can be applied once the begin button 1301 is selected.

In addition to the ‘learn mode’ described above, the system can also be used in connection with a force sensing device or other sensors to obtain feedback from a person performing exercises to import back into the exercise system. This feedback can be used for monitoring aspects of physical performance such as compliance with an exercise program, or monitoring for fatigue. With that additional information, the exercise instructor and/or the patient or athlete can then take specific actions based on that analysis, for example to perform the exercises in a different manner or to make adjustments to the exercise program.

With respect to compliance with an exercise program, parameters that could be monitored using the force sensor could include: whether the athlete/patient is doing the correct number of sets/repetitions, is his/her timing correct, is he/she pulling with enough force, etc. The system can track, store, and analyze this information with every performance of the routine, and compliance and progress can be recorded and measured, and exercise programs adjusted as appropriate for the situation.

Another use of this sensor feedback with respect to these parameters is fatigue analysis. As a user gets tired, various parameter values may change, and the system can monitor such changes. For example, as the patient fatigues, the patient may: rest longer between each repetition (the time between the down-crossing of the lower force target to the up-crossing of that target for the next repetition); take longer to achieve the upper force target (the time between the up-crossing of the lower force target to the up-crossing or meeting of the upper target); take longer for the overall repetition; be unable to sustain a slower release phase (less controlled release, dropping from the upper target to the lower target faster than prescribed); have the peak force per repetition diminish over time (the amount the patient or athlete go past the upper-target gets smaller as they fatigue); exhibit less steadiness/smoothness of the force curve as he/she performs subsequent repetitions (the force curve gets “jittery”); unable to achieve as long of a hold time at or above the upper-target threshold; perform fewer repetitions in a given time interval; exhibit less explosive power (force divided by time) in the pull phase of the exercise; and other such sensor-based performance feedback. The system can track, store, and analyze fatigue data, and adjust exercise programs as appropriate for the situation.

The system can also be used to identify the type of weights or equipment to use for each exercise based upon the force targets determined. For example, if the system is used with a force sensing device 104, the system can indicate which variable resistance cables to use 1207. In the example shown in FIG. 12, R5 cables are indicated.

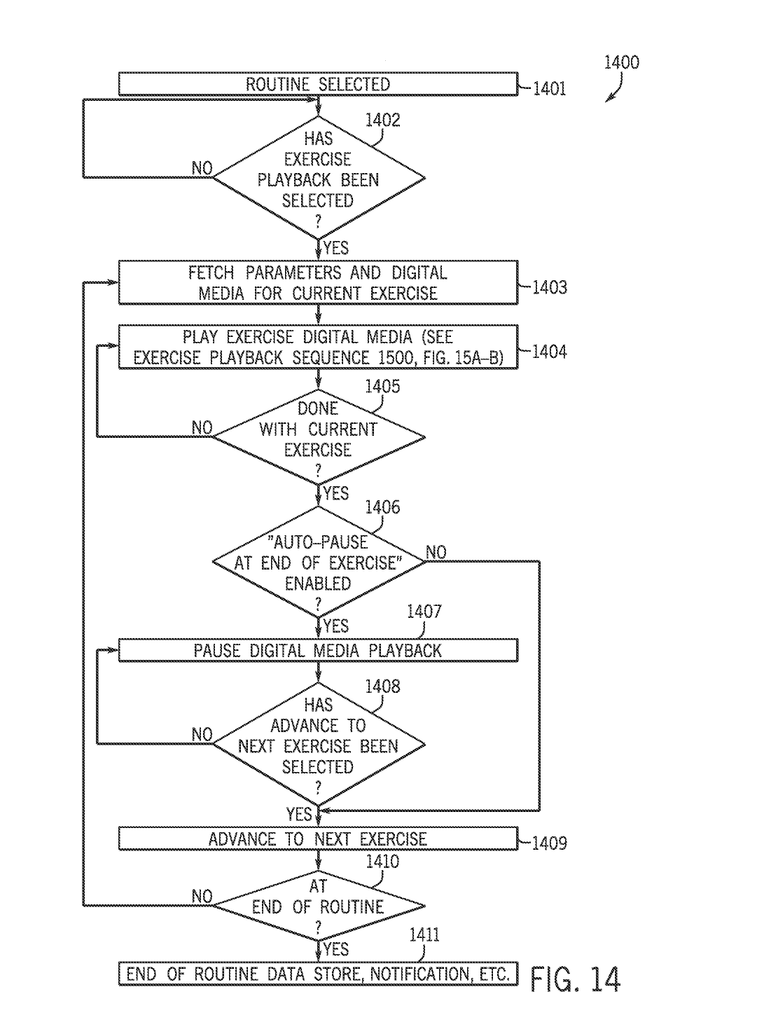

FIG. 14 is a flow chart that illustrates a playback sequence 1400 performed by the exercise system. First, a routine is selected 1401. Then, at decision gate 1402, the system is configured such that when exercise playback has been selected, the system will fetch parameters, such as the phase data entry fields 801-805, the phase force fields 1201-1203 and/or duration parameters 1208 and digital media for the current exercise at step 1403. If exercise playback has not been selected, the sequence continues to check if the exercise playback has been selected. Then the system plays the exercise digital media at step 1404 in accordance with the exercise playback sequence 1500 as seen in the flow chart of FIGS. 15A and 15B. Once the exercise playback sequence 1500 has been completed, the system is configured such that it will check to determine if the exercise has been completed at decision gate 1405. For example, if the number of repetitions has been set to five, as seen in FIG. 12, the system at decision gate 1405 will determine if the exercise has been repeated five times. If the exercise has been completed, the system will pause the current digital media playback 1407 if the auto-pause at end of exercise has been enabled at decision gate 1406 of the routine playback sequence 1400. If the auto-pause at end of exercise is not enabled, the routine playback sequence 1400 skips to step 1409. If the exercise has not been completed, the system will again play the exercise digital media at step 1404 in accordance with the exercise playback sequence 1500.

At decision gate 1408, when an election is made to advance to the next exercise, the system will advance to the next exercise at step 1409. If advance to the next exercise has not been selected, the sequence returns to pausing the current digital media playback 1407. After advancing to the next exercise 1409, the system checks if playback has reached the end of the routine at decision gate 1410. If at the end of the routine, the system can upload to the database server 107 or cloud 108 the results of the athlete or patient's routine, including the time it took to complete each exercise, for example, to compare actual performance to what was prescribed, the total overall time, if any exercises were skipped as indicated, for example, by a sensor or the amount of time the athlete or patient viewed a digital media, or force readings for any given exercise. The athlete or patient can be allowed to provide manual feedback about the routine, e.g., pain scale, difficulty with exercises, questions for the instructor, and allow notifications back to the instructor that the patient has completed the routine at step 1411. If not at the end of the routine, the system will play the next exercise digital media at step 1404.

FIGS. 15A and 15B are flow charts that illustrate a typical exercise playback sequence 1500 played according to customized timing. As discussed above, the exercise playback sequence 1500 can be initiated at step 1404 of the routine playback sequence 1400. For example, when the routine playback sequence 1400 reaches the play the exercise digital media at step 1404, the exercise playback sequence 1500 is initiated and the system calculates the pull time and release time custom playback frame rates for the current exercise based at least in part on the length of the pull phase, as indicated by the pull time field 802, and the length of the release phase, as indicated by the release time field 804. Then, at decision gate 1502, the system is configured such that when the frame rates calculated at step 1501 are greater than the playback system's playback capabilities, the system will set the next calculated frame logic at a frame rate within the playback system's capabilities such that some frames will be skipped at step 1503, and then proceed to decision gate 1504.

For example, a playback system may be capable of playing only as fast as 30 frames per second. The exercise may have 40 frames between the selected start frame 503 and the selected end frame 504. If the pull time field 802 is set to 0.67 seconds and the reverse control 407 is selected, the resulting frame rate is 60 frames per second (40 frames/0.67 seconds). One way of playing the modified digital media 510 on the system limited to just 30 frames per second, is to skip every-other frame instead of advancing to every frame. The result is the modified digital media 510 being able to be played at the playback system's 30 frames per second limit. If the frame rates calculated at step 1501 are not greater than the system's capabilities, the system will proceed to decision gate 1504. Therefore, the frame logic of the system can be set to any frame rate at or below the system's capabilities.

At decision gate 1504, the system is configured such that when the starting ROM frame, e.g. selected start frame 503, has been set to a frame greater than, or other than, the first frame, the system will advance the digital media to the starting ROM frame at step 1505. Then the system will proceed to show the selected start frame 503 and the proceeding frames associated with the pull phase at step 1506. If the selected start frame 503 is the first frame, the system will proceed to show the media frame at step 1506.

At decision gate 1507, the system is configured such that when the pull phase display time has elapsed for that frame, as indicated by the calculated frame rate logic for example, using the number of frames in between the selected start frame 503 and the hold frame divided by the pull time field 802 when the loop control 406 is selected, the system proceeds to advance to the next calculated frame at step 1508 and then to decision gate 1509. If the pull phase display time has not elapsed, the system continues to check if the pull phase display time has elapsed.

At decision gate 1509, the system is configured such that when the playback is at the hold frame, the system will show the hold frame of the digital media at step 1510 and then proceed to decision gate 1511. For digital media where the loop control 406 is designated, the hold frame must be designated as described above and represented in FIG. 15A as the hold marker. If the playback is not at the hold frame, the system will revert back to showing the current frame of the digital media at step 1506.

At decision gate 1511, the system is configured such that when the hold phase display time has elapsed, as indicated by the hold time field 803, the system will proceed to decision gate 1512. If the hold phase display time has not elapsed, the system will continue to check if the hold phase display time has elapsed, effectively keeping the hold frame of the digital media on display as a freeze-frame for the duration of the hold period.

At decision gate 1512, the system is configured such that when the digital media is to be played back-and-forth, such as by selection of the reverse control 407, the system will return to the frame of the digital media immediately preceding the hold frame 1513 and then play the frames of the digital media in reverse order 1516. When the reverse control 407 is not selected, the system will proceed to the next frame of the digital media 1514 and then continue playing the frames of the digital media in forward progression at step 1517. From the steps 1516, 1517, the exercise playback sequence 1500 continues as seen in FIG. 15B, where the system shows the frames of the digital media 1518 and then proceeds to decision gate 1519.

At decision gate 1519, the system is configured such that when the release phase display time has elapsed for that frame, as indicated by the calculated frame rate logic, for example, using the number of frames in between the hold frame and the selected end frame 504 divided by the release time field 804 when the loop control 406 is selected and the playback system's capabilities, the system will advance to the next calculated frame of the digital media at step 1520 and then proceed to decision gate 1521. If the release phase display time has not elapsed, the system will continue to check if the release phase display time has elapsed, thus providing a custom playback speed of the digital media matching the timing parameters specified by the exercise instructor.

At decision gate 1521, the system is configured such that when the end of repetition has been reached, the system will show the final frame of the digital media and then proceed to decision gate 1523. For digital media where the loop control 406 is designated, the end of repetition is the selected end frame 504. For digital media where the reverse control 407 is designated, the end of repetition is the selected start frame 503. If the end of repetition has not been reached, the system will revert back and continue to show the frame of the digital media at step 1518.

At decision gate 1523, the system is configured such that when the rest phase has elapsed, as indicated by the repetition rest time field 805, the system recognizes that the end of repetition has been reached at step 1524, thereafter continuing in the routine playback sequence 1400 at decision gate 1405 as previously discussed. If the rest phase has not elapsed, the system will continue to check if the rest phase has elapsed and continues to show the final frame of the exercise.

Although the system as shown and described with regards to FIGS. 14, 15A and 15B has been described using the term frame, any type of digital media can be used with the system and, as such, the term frame as used with regards to FIGS. 14, 15A and 15B can mean video frame, animation frame, image, picture, drawing or any other type of visual representation.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. An exercise system for use with a computing device to modify and demonstrate an exercise having a number of phases, the exercise system comprising:
an interface for displaying a digital media of the exercise on the computing device;
a start marker for indicating a segment of the digital media at which the exercise should start;
an end marker for indicating a segment of the digital media at which the exercise should end;
a selection means for indicating a portion of the digital media representing each phase of the exercise; and
a processing means for preparing a modified digital media based on the start marker and end marker and for indicating the portion of the digital media representing each phase, the modified digital media used to demonstrate the exercise.

2. The exercise system of claim 1, wherein the digital media can be of a type selected from the group consisting of animations, videos, images, pictures and drawings.

3. The exercise system of claim 2, wherein the digital media is created by a user.

4. The exercise system of claim 1, further comprising a library of exercise digital media files.

5. The exercise system of claim 1, wherein the interface further displays a playback control for receiving selection of a playback method; and wherein the processing means designates that the modified digital media be displayed in reverse after the modified digital media is displayed on a computing means for a first time.

6. The exercise system of claim 1, wherein the interface further displays a playback control for receiving selection of a playback method; and wherein the processing means designates that the modified digital media be displayed again after the modified digital media is displayed on a computing device for a first time.

7. The exercise system of claim 1, further comprising a display representing each phase of the exercise, the display receiving temporal inputs relating to a period of time for each phase of the exercise; and wherein the processing means uses the temporal inputs to set a speed at which the modified digital media is displayed.

8. The exercise system of claim 1, wherein the processing means further receives force inputs during performance of an exercise; and wherein the interface displays a graphical representation of each phase of the exercise as a function of the corresponding force inputs.

9. An exercise system for use with a computing device to modify a digital media of an exercise, the exercise system comprising:
an interface capable of being displayed on a computing device for facilitating identification of a period of time for each phase of the exercise by receiving temporal inputs from a user;
a selection means for indicating segments of the digital media representing each phase of the exercise; and
a processing means for using the temporal inputs to set a speed at which the segments of the digital media representing each phase of the exercise are displayed on the computing device.

10. The exercise system of claim 9 wherein the processing means further receives routine inputs and duration parameters relating to the characteristics of an exercise program.

11. The exercise system of claim 10 wherein the interface further displays a period of time to perform the exercise program based at least on the routine inputs, duration parameters and temporal inputs.

12. The exercise system of claim 9 wherein the interface graphically displays each phase of the exercise as a function of time according to the temporal inputs.

13. The exercise system of claim 12, wherein between each phase is a transition that is displayed on the graphic display as a function of time and is selectable by the user;
wherein the interface receives temporal inputs from the user when the transition is selected and changed by the user; and
wherein changing the transition changes the period of time for at least one phase of the exercise.

14. The exercise system of claim 13, wherein the interface also displays a numeric representation of the period of time for each phase of the exercise;
wherein the interface is configured to update the numeric representation by receiving numeric value inputs from a user and to update the graphic display when the numeric value inputs are received, the graphic display and numeric representation indicate the same period of time for each phase.

15. The exercise system of claim 14 further receiving force inputs for identifying a force target for at least two phases of the exercise.

16. The exercise system of claim 15, wherein each transition is also displayed as a function of force based on the force inputs;
wherein at least one of the force inputs from the user is received when the transition is selected and changed by the user; and
wherein changing the transition changes the force target for at least one phase of the exercise.

17. The exercise system of claim 15 wherein the force target includes a maximum force target for at least one phase of the exercise and a minimum force target for at least one phase of the exercise.

18. The exercise system of claim 16 wherein the interface also facilitates the user in identifying a warning force for at least one phase of the exercise.

19. The exercise system of claim 17 wherein the interface is configured to identify exercise equipment for use during the exercise based upon the maximum force target and minimum force target.

20. An exercise system for determining a force target at which an exercise having a number of phases is performed comprising:
a sensor for measuring forces created during performance of the exercise and for sending a signal representing the measured forces;
a memory for receiving the signal; and
a processor for determining a force target for the exercise based on the signal.

21. The exercise system of claim 20 wherein the force target is a minimum force for the exercise.

22. The exercise system of claim 20 wherein the force target is a maximum force for the exercise.

23. The exercise system of claim 20 wherein the memory also receives timing information and the processor is also capable of determining a period of time for each phase of the exercise.

24. The exercise system of claim 22 further comprising an interface for facilitating the user in identifying a value for at least one feature of the group consisting of a number of repetitions to analyze, a fraction of the largest measured forces for use in determining the force target, smallest increment for rounding the force target, smallest increment for rounding the period of time, and weighted adjustment for each repetition.

25. An exercise system for demonstrating an exercise routine, the system comprising:
a computing device having an interface;
a library of digital media files of exercises on a server, the digital media capable of being played on the interface; and
a processor for receiving data inputs regarding a selection of the digital media files for inclusion in the exercise routine;
wherein the exercise routine can be played by a second computing device to demonstrate the exercise routine.

26. The exercise system in claim 25, further comprising a force sensor used when the exercise routine is performed and wherein the processor receives data from the force sensor.

27. The exercise system of claim 26, wherein the data received from the force sensor relates to fatigue.

28. The exercise system of claim 27, wherein the data received from the force sensor relates to compliance with the exercise routine.
